(19) United States
(12) Patent Application Publication
(10) Pub. No.: US 2023/0005630 A1
(43) Pub. Date: Jan. 5, 2023

(54) METHOD AND ARRANGEMENT FOR CLEANING LIQUID

(71) Applicant: SIEMPELKAMP NIS INGENIEURGESELLSCHAFT MBH, Alzenau (DE)

(72) Inventors: Andreas LOEB, Niddatal (DE); Markus THOMA, Johannesberg (DE); Markus BECKER, Kleinostheim (DE); Anna PRÜLLAGE, Dossenheim (DE); Laura SCHNEIDER, Offenbach (DE)

(73) Assignee: SIEMPELKAMP NIS INGENIEURGESELLSCHAFT MBH, Alzenau (DE)

(21) Appl. No.: 17/781,453

(22) PCT Filed: Dec. 4, 2020
(86) PCT No.: PCT/EP2020/084645

§ 371 Date: Jun. 1, 2022

(30) Foreign Application Priority Data
Dec. 23, 2019 (DE) 10 2019 135 684.9

(51) Int. Cl. G21D 1/00; G21F 9/06; G21F 9/12

(52) U.S. Cl. CPC G21D 1/003; G21F 9/06; G21F 9/12

(57) ABSTRACT

The invention relates to a method and an arrangement for operating a system in which dismantling works are performed underwater in a liquid-filled vessel (10) of a nuclear facility, the liquid being guided in a circuit (20) and flowing through at least one filter device (26, 28, 30). The liquid in the circuit flows through at least a first filter device (26) in the form of a coarse filter and a second filter device (28), in which at least one device from the group of ion exchangers (1, 2, 3), reverse osmosis systems, ultrafiltration systems, activated carbon filters, zeolite filters, and biological filters is used for filtration.

The invention relates to a method for operating a system in which dismantling works are performed underwater in a liquid-filled vessel of a nuclear facility, such as a reactor pressure vessel or fuel element well or reactor well, wherein the liquid is guided in a circuit and flows through at least one filter device.

The invention also makes reference to an underwater dismantling arrangement, comprising a liquid-filled vessel of a nuclear facility, such as a reactor pressure vessel or fuel element well or reactor well, as well as a liquid circuit enclosing the vessel, in which liquid circuit at least one filter device is arranged.

Devices can be dismantled under water in nuclear facilities, wherein the corresponding activities are carried out remotely supported by audio and video technology. Therefore, the water quality is of essential importance, because any worsening thereof will at least make these dismantling activities more difficult if not impossible even. Depending on the operation, e.g. due to the metered adding of zinc or implementing of decontamination processes, residues of, for example, nickel oxalate, iron oxalate, zinc compounds, or deposits such as salts, oxides, CRUD, i.e. spongy or crusty deposits, may be present on the metal surfaces particularly of the primary circuit systems. Thermal dismantling processes such as, e.g., plasma gas cutting, can be used during the underwater dismantling. Due to the high process temperatures and the incorporation of cutting gases, surface deposits can react and thus enter the water. Furthermore, reactions can occur between the cutting gas and liquid due to the high process temperatures, and the resulting compounds can enter the water.

In addition, metal ions, such as iron, chromium, nickel, and manganese ions, or radionuclides can be dissolved in water in significant quantities and that is both during thermal and during mechanical dismantling. The latter can be implemented by means of cutting, for example. Moreover, hazardous substances which are harmful to health and carcinogenic, such as chromium (VI) and nickel compounds, can be released and enter the water.

If the solution is oversaturated with metal ions or metal compounds, the substances can precipitate out as deposits, whereby the view is significantly impacted to the extent that there is no longer a clear view as required for the underwater dismantling.

The water quality is often impacted due to the prolonged dismantling works, which can last weeks or months, when the water is easily heated, there are many ions in the water, and oxygen is dissolved due to the circulation, such that an ideal breeding ground forms for the growth of microorganisms or algae. This also negatively impacts the viewing conditions. Furthermore, negative effects such as, e.g., corrosion, can result on the dismantling tools.

DE 90 15 427 U1 discloses a device for underwater dismantling of contaminated components of a nuclear facility. During the dismantling, any chips and abraded particles present are deposited into an external filter, which is arranged in a liquid circuit, into which the fuel pool of the nuclear facility is integrated.

In order to carry out cleaning of a liquid in which irradiated components are dismantled, DE 696 06 778 T2 provides for filtered devices used in series, wherein initially the coarsest impurities are retained by means of a pre-filtering sieve and then filter cartridges are used for fine filtering.

JP 2016-133 362 A relates to a method for decontamination of a water tank. To this end, a nozzle module is inserted into the water tank, by means of which nozzle module the wall of the tank is exposed to liquid which is being suctioned from the tank, in order to supply a plurality of filter units, which may be activated carbon filters, after the liquid flows through an intermediate tank. Zeolite is used to adsorb strontium.

U.S. Pat. No. 6,197,188 B1 discloses a filter system for coarse and fine filtering. In this case, particles of a size between 0.3 and 0.5 μm or between 15 and 50 μm are filtered out in a filter unit.

The subject matter of DE 43 38 851 A1 is the treating of contaminated water to form potable water by means of microfiltration.
According to DE 100 05 681 A1, metal-containing or radioactively contaminated water is routed in a circuit, wherein, e.g., radionuclides are removed from the circuit by means of cation exchange and anions are removed by means of electrochemical deposition.

DE 693 12 966 T2 relates to a method for dissolving oxides which have deposited onto metal parts. In this case, a chemical decontamination is implemented in order to keep people working in the area of a water tank of a steam generator from having high levels of exposure.

A method for remote dismantling of irradiated components is known from DE 696 06 778 T2.

DE 10 2012214 853 B3 describes a system for treating a mixture of water and solids occurring in a nuclear facility during jet cutting with a suspension of water and abrasive agent.

According to US 2016/0211040 A1, in order to treat radioactive waste water, filters are used in series; these may be electrostatic filters, zeolite filters, or anion exchangers or cation exchangers.

In order to clean biologically or radioactively contaminated water, particularly water from laundries, U.S. Pat. No. 4,975,199 A provides for particulate filters in order to then supply this removed water to reverse osmosis systems.

The object of the present invention is to refine a method and an arrangement of the aforementioned type such that negative impacting of the viewing conditions as well as an accumulation of hazardous substances are prevented during underwater dismantling.

In order to achieve the object, it is essentially proposed according to the method that the liquid flows through at least one first filter device in the form of a coarse filter and one second filter device, in which at least one device from the group comprising ion exchangers, reverse osmosis systems, ultrafiltration systems, activated carbon filters, zeolite filters, or biological filters is used for the filtration, and that at least the first and/or the second filter device, preferably both the first and the second filter device, is/are arranged in the vessel.

However, it is also possible for the first filter device to be arranged within the vessel and the second filter device to be arranged outside the vessel. If the second filter device is positioned outside the vessel, a simple exchange of ion exchanger resins or a maintenance of the filter of the second filter device can easily be implemented.

The vessel is part of the circuit.

In this case, it is particularly provided that the liquid flows through the first and one further filter device before flowing through the second filter device.

The first filter device may be a coarse filter, such as a sand filter or wire mesh filter with a filter fineness or pore size between 1 mm and 5 mm so that particles between 1 mm and 5 mm are filtered out of the liquid from the circuit.

The further filter device is a fine filter and may have, e.g., one or more filter cartridges, such as activated carbon cartridges or wound filter cartridges, with a filter fineness between 1 μm and 150 μm.

In other words, according to the invention, a water treatment is carried out during dismantling of devices underwater in that the water initially flows through a coarse filter, then a fine filter, and finally a filter device, in which at least one filter from the group comprising ion exchangers, reverse osmosis systems, activated carbon filters, ultrafiltration systems, zeolite filters, and biological filters is used.

In this case, the liquid flows within the circuit in the vessel itself. According to the invention, a closed system in the vessel is used, i.e. the liquid is guided through the circuit in the vessel itself, in order to separate out particles so that any negative impact on the viewing conditions during dismantling is suppressed.

If the filter devices are positioned within the vessel, there is the additional advantage that the radioactive load is not increased outside of the vessel because the liquid remains in the vessel. Dirt and harmful substances are removed at the same time as the dismantling process. This suppresses the accumulation of harmful substances in the liquid and prevents corrosion of dismantling devices.

The ion exchanger is particularly a cation exchanger or anion exchanger or cation exchanger or anion exchanger.

The cation exchanger should be a strongly or weakly acidic cation exchanger and/or the anion exchanger should be a strongly or weakly alkaline anion exchanger.

A selective ion exchanger could also be used as the ion exchanger in order to bind, e.g., Li, Cs, or radionuclides.

According to the prior art, if the liquid present during the underwater dismantling flows through two filter devices, which typically enable a coarse and a fine filtration, which are arranged outside of the vessel and thus lead to a radioactive load in the environment of the vessel, it is provided according to the invention that, on the one hand, a cleaning of the liquid takes place in the vessel itself and, on the other hand, a special filter step is provided which ensures that the ions, microorganisms, or radionuclides causing an impact are removed from the liquid such that a clear view is provided even when the dismantling works are carried out over a long period of time, i.e. weeks and possibly months, and/or at temperatures which particularly provide a breeding ground for the growth of microorganisms and algae.

According to the invention, an accumulation of harmful substances in the liquid is prevented. An increase in the ambient dose rate and corrosion on the dismantling devices are also suppressed.

In particular, the invention provides that the second filter device comprises several ion exchangers, such as radionuclide-selective ion exchangers and/or anion exchangers and/or cation exchangers, which are arranged fluidically in parallel and/or in series.

An arrangement of the aforementioned type is characterized in that at least one first and one second filter device are arranged in the circuit, in that the first filter device is a coarse filter and the second filter device is a device from the group comprising ion exchangers, reverse osmosis systems, ultrafiltration systems, zeolite filters, activated carbon filters, and biological filters, and in that the first and/or second filter device, particularly the first and the second filter device, is/are arranged in the vessel.

In particular, the invention also provides that the second filter device is positioned upstream of a further filter device, wherein particularly the first filter device is a coarse filter and the second filter device is a fine filter.

The further filter device, i.e. the fine filter, should be or is also arranged in the vessel.

Alternatively, it is possible for the first filter device to be arranged within the vessel and the second filter device to be arranged outside the vessel. The further filter device may be arranged in the vessel or outside the vessel.

Regardless of this, the second filter device should have at least two ion exchangers, which are used fluidically in series or in parallel.

Preferably, the second filter device has at least one ion exchanger from the group comprising radionuclide-selective ion exchangers, anion exchangers, or cation exchangers.

Further details, advantages, and features of the invention result not only from the claims, the features to be taken from said claims—on their own and/or in combination—as well as the exemplary embodiments to be obtained from the following description of the drawing.

The following is shown:

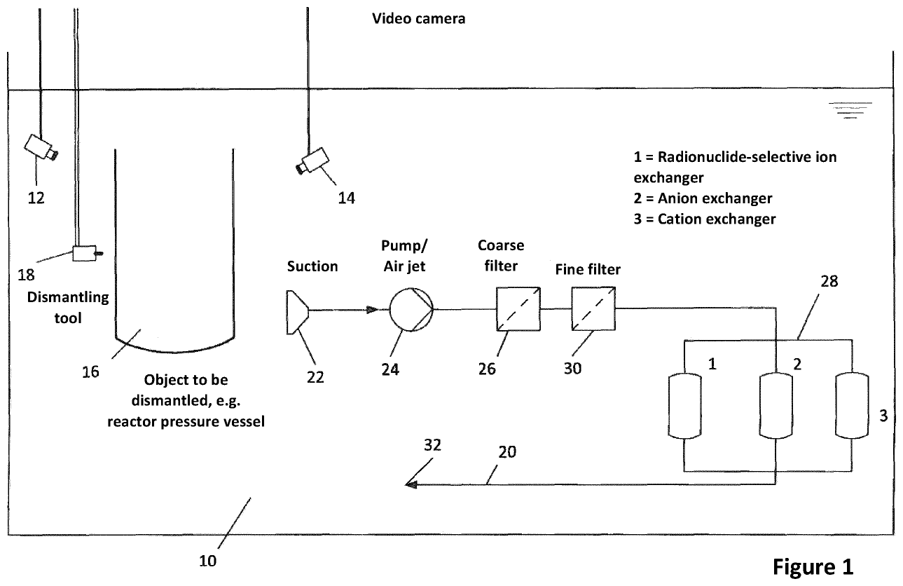

FIG. 1 a first exemplary embodiment of an underwater dismantling arrangement; and

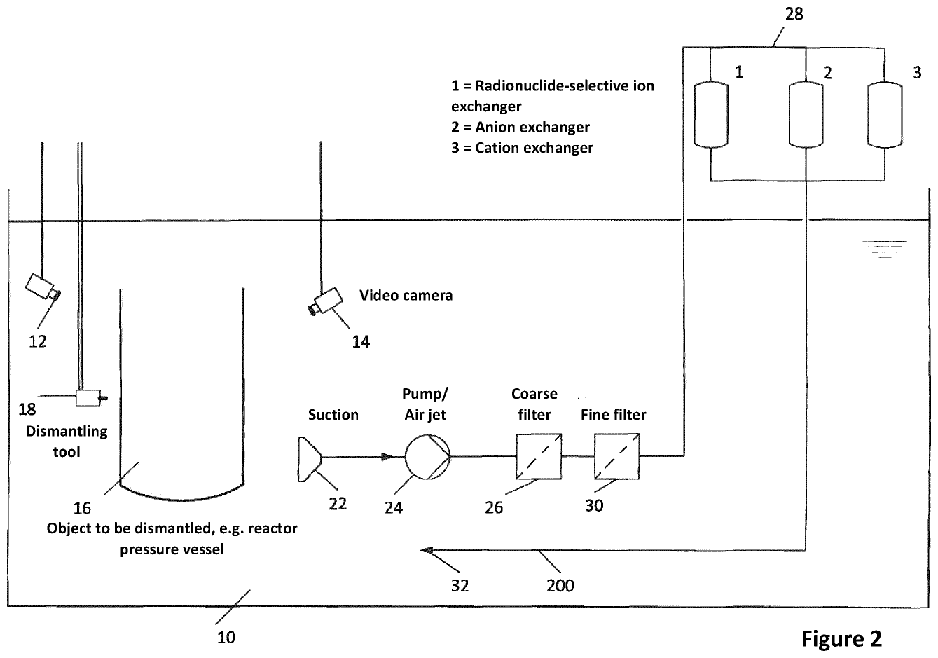

FIG. 2 a second embodiment of an underwater dismantling arrangement.

FIG. 1 shows, as a first exemplary embodiment of the teaching according to the invention, a section of a water-filled vessel 10 of a nuclear facility, such as reactor wells, in which underwater dismantling works are carried out. These dismantling works are carried out remotely, inter alia, by means of video technology. Purely as an example, FIG. 1 shows two video cameras 12, 14 which provide images of an object 16 to be dismantled, which is dismantled by means of a tool 18. The liquid, i.e. the water, flows through several filter devices so that the view is not negatively impacted, e.g. due to turbidity of the water, so that there can be trouble-free control of the dismantling tool, optionally automatically, using the images obtained from the video cameras 12, 14. According to the invention, the water is routed within the vessel 10 in a circuit 20 in this case.

An intake port 22 is situated in the liquid in order to suction the liquid using a pump 24 so that the suctioned liquid can flow through the circuit 20. The circuit 20 contains a coarse filter 26 as the first filter device, a second filter device 28 of the embodiment as described subsequently, as well as a further filter device 30, which is a fine filter, arranged in the circuit between the first filter device 26 and the second filter device 28.

Particles a size of, e.g., 1 mm to 5 mm and greater are filtered out by means of the first filter device, i.e. the coarse filter 26.

The coarse filter 26 is particularly a perforated cylinder, wire mesh filter, or one or more filter cartridges or combinations of several of these filters.

The fine filter 30 arranged downstream of the coarse filter 26 in the circuit 20 should have one or more fine filter cartridges and/or one or more wound filter cartridges, or one or more metal-edge filters in order to enable fine filtering of particles of up to 150 μm.

The fine filter 30 can also be one or more activated carbon cartridges.

The second filter device 28 is arranged downstream of the fine filter 30 in the circuit 20; in the exemplary embodiment, this filter device comprises three individual filters used in parallel: a radionuclide-selective ion exchanger 1, an anion exchanger 2, as well as a cation exchanger 3. It is also possible to replace one or more of the ion exchangers, e.g., with an activated carbon filter and/or zeolite filter and/or ultrafiltration system and/or reverse osmosis system and/or biological filter or to consider these in a supplemental manner.

If the filters 1, 2, 3 in the exemplary embodiment are used in parallel, an arrangement in series or also a combination of parallel and series arrangements are possible.

The outlet (arrow 32) of the second filter device 28 opens into the vessel liquid, resulting in the circuit 20.

The second filter device 28 provides the advantage that particularly metal ions, such as iron ions, chromium ions, nickel ions, manganese ions, as well as radionuclides can be filtered out.

Microorganisms and harmful substances can also be filtered out. These measures prevent turbidity of the water and the accumulation of harmful substances in the vessel 10.

The flow particularly through the second filter device 28 ensures good water quality which prevents breeding grounds for the growth of microorganisms or algae from being formed.

Thus, a trouble-free dismantling operation is possible.

FIG. 2 shows a second exemplary embodiment, which is an arrangement for the underwater dismantling of components, particularly in a nuclear facility. In this case, the same reference numerals are used for the same elements in accordance with FIG. 1.

According to the exemplary embodiment in FIG. 2 as well, the liquid present in the wells 10 is guided in a circuit 200, wherein the first filter device 26 and the further filter device 30 are arranged in the vessel 10 and the second filter device 28 is arranged outside the vessel 10, which is obvious from FIG. 2 and deviates from FIG. 1. Otherwise, the procedure and the liquid circuit are the same in order to prevent negatively impacting the viewing conditions as well as an accumulation of harmful substances in the liquid during the underwater dismantling works. In order to achieve this, the liquid is suctioned via the intake port 22 by means of the pump 24 so that the liquid can flow in the circuit 200 in which the first filter device 26 and the further filter device 30 are located, and that is within the vessel 10, in order to then guide the circuit 200 out of the vessel 10 and enable the liquid to flow through the second filter device 28. Subsequently, the circuit is guided back into the vessel 10. The types of filter devices 26, 28, 30 correspond to those which have been explained in connection with FIG. 1 such that reference is made to the embodiments related thereto.

1. A method for operating a system in which dismantling works are performed underwater in a liquid-filled vessel (10) of a nuclear facility, such as a reactor pressure vessel or fuel element well or a reactor well, wherein the liquid is guided in a circuit (20, 200) and flows through at least one filter device (26, 28, 30),
characterized in that
the liquid in the circuit (20, 200) flows through at least one first filter device (26) in the form of a coarse filter and one second filter device (28), in which at least one device from the group comprising ion exchangers (1, 2, 3), reverse osmosis systems, ultrafiltration systems, activated carbon filters, zeolite filters, and biological filters is used for filtration, and in that the first and/or the second filter device is arranged in the vessel (10).

2. The method according to claim 1,
characterized in that
the liquid flows through the first filter device (26) and a further filter device (30) arranged downstream thereof before flowing through the second filter device (28).

3. The method according to claim 1,
characterized in that
a coarse filter, particularly a perforated cylinder, wire mesh filter, or filter cartridge is used as the first filter device (26), particularly with a filter fineness between 1 mm and 5 mm, and/or a fine filter, particularly one or more fine filter cartridges, wound filter cartridges, or metal-edge filters are used as the further filter device (30), particularly with a filter fineness between 1 μm and 150 μm.

4. The method according to claim 1,
characterized in that
the second filter device (28) comprises several ion exchangers (1, 2, 3), which are arranged fluidically in parallel and/or in series.

5. The method according to claim 1,
characterized in that
the first filter device (26) is arranged within the vessel (10) and the second filter device (28) is arranged outside the vessel.

6. An underwater dismantling arrangement, comprising a liquid-filled vessel (10) of a nuclear facility, such as a reactor pressure vessel or fuel element well or reactor well, as well as a liquid circuit (20, 200) enclosing the vessel, in which circuit at least one filter device (26, 28, 30) is arranged,
characterized in that
at least one first and one second filter device (26, 28) are arranged in the circuit (20, 200), in that the first filter device (26) is a coarse filter, and the second filter device (28) is a device from the group comprising ion exchangers (1, 2, 3), reverse osmosis systems, ultrafiltration systems, zeolite filters, activated carbon filters, and biological filters, and in that the first and/or the second filter device is or are arranged in the vessel (10).

7. The arrangement according to claim 6,
characterized in that
a further filter device (30) is arranged upstream of the second filter device (28) in the circuit (20, 200).

8. The arrangement according to claim 6,
characterized in that
the first filter device (26) is a coarse filter, particularly a perforated cylinder, wire mesh filter, or filter cartridge, particularly with a filter fineness between 1 mm and 5 mm, and/or the further filter device (30) is a fine filter, particularly one or more fine filter cartridges, wound filter cartridges, or metal-edge filters, particularly with a filter fineness between 1 μm and 150 μm.

9. The arrangement according to claim 6,
characterized in that
the second filter device (28) has at least two ion exchangers (1, 2, 3), which are used fluidically in series or in parallel.

10. The arrangement according to claim 6,
characterized in that
the second filter device (28) is or comprises at least one ion exchanger from the group comprising radionuclide-selective ion exchangers, anion exchangers, or cation exchangers.

11. The arrangement according to claim 6,
characterized in that
the first filter device (26) is arranged within the vessel (10) and the second filter device (28) is arranged outside the vessel.
